(19) United States
(12) Patent Application Publication
(10) Pub. No.: US 2010/0289924 A1
(43) Pub. Date: Nov. 18, 2010

(54) IMAGER THAT ADDS VISUAL EFFECTS TO AN IMAGE

(75) Inventors: Naoki KOSHIKAWA, Saitama (JP); Teppei OKAMOTO, Saitama (JP); Koichi ISHIBASHI, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/779,247

(22) Filed: May 13, 2010

(30) Foreign Application Priority Data
May 14, 2009 (JP) 2009-117343

(51) Int. Cl. H04N 5/262

(52) U.S. Cl. 348/239; 348/E05.051

(57) ABSTRACT

An imager is provided having an imaging sensor and an image processor. The imaging sensor creates an image signal by photographing a subject. The image processor creates image data by processing the image signal, conducts a visual effects process, and stores post-processing information that includes information based on the visual effects process in the image data, so that an image file is created.

### BACKGROUND OF THE INVENTION

1. Field of the Invention

The present invention relates to an imager that adds visual effects to an image.

2. Description of the Related Art

Japanese Unexamined Patent Publication Number 2000-182044 discloses an imager that adds visual effects to a photographed image. A visual effect is added by a digital filter, for example. A photographed image that has been enhanced with one or more visual effects is represented on a display provided in the imager.

However, when viewing a photographed image it may be difficult for a user to determine whether or not the image has been enhanced with a visual effect, or recognize the particular visual effect that was applied. Especially, in the case that multiple visual effects are applied to the image data, it is difficult for a user to recognize how visual effects are applied only by viewing a represented image.

### SUMMARY OF THE INVENTION

An object of the present invention is to provide an imager that records process of visual effects produces in an image file.

An imager is provided having an imaging sensor and an image processor. The imaging sensor creates an image signal by photographing a subject. The image processor creates image data by processing the image signal, conducts a visual effects process, and stores post-processing information that includes information based on the visual effects process in the image data, so that an image file is created.

### BRIEF DESCRIPTION OF THE DRAWINGS

The objects and advantages of the present invention will be better understood from the following description, with references to the accompanying drawings in which:

FIG. 1 is a block diagram of an imager according to the embodiment of the present invention;

FIG. 2 shows a file structure before visual effects are added to an image file;

FIG. 3 shows the file structure of an image file to which visual effects are added immediately after photographing;

FIG. 4 shows the file structure of an image file in which post-processing information is recorded;

FIG. 5 shows the file structure of an image file in which visual effects were added immediately after the file was retrieved from a recorder;

FIG. 6 shows a display indicating a visual effects procedure according to a second operation;

FIG. 7 shows a display indicating a visual effects procedure according to a third operation;

FIG. 8 is a flowchart of a recurrence process;

FIG. 9 shows variations in the file structure of an an image file to which visual effects have been added;

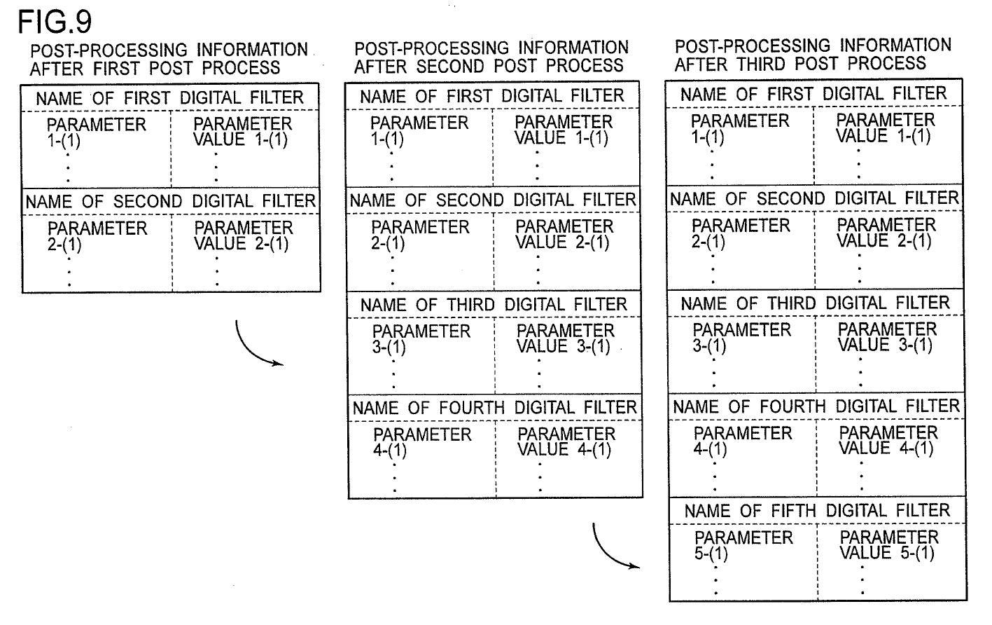

FIG. 10 shows variations in the file structure of an image file to which visual effects have been added; and

FIG. 11 shows variations in the file structure of an image file to which visual effects have been added.

### DESCRIPTION OF THE PREFERRED EMBODIMENTS

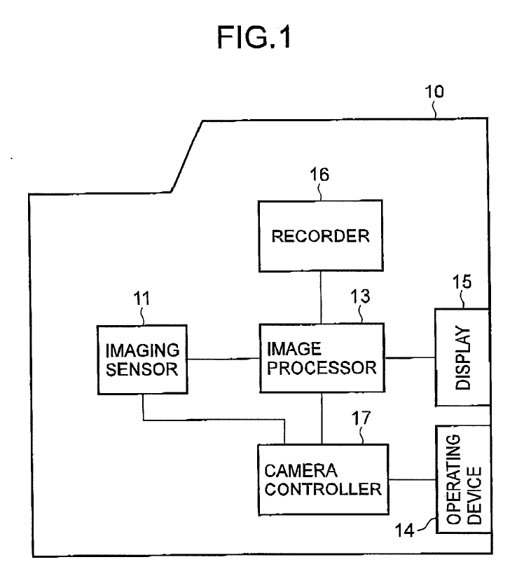

The present invention is described below with references to the embodiment shown in the drawings. FIG. 1 shows the imager according to this embodiment is a digital camera 10 equipped with an imaging sensor 11, an image processor 13, an operating device 14, a display 15, a recorder 16, and a camera controller 17.

Light reflected from a subject enters through a lens (not shown), and is captured by the imaging sensor 11, which then outputs an image signal to the image processor 13. The image processor 13 creates image data by processing the image signal, and then sends the image data to the display 15. The display produces a visual image according to the image data. The image processor 13 creates an image file from the image data, and then sends the image file to the recorder 16, which is a recording medium in which image files are stored. The camera controller 17 controls each process carried out by the image processor 13 of the digital camera 10.

When a user performs a first operation with the operating device 14, the image processor 13 processes the image data with a digital filter and sends the processed image data, i.e. the image file, to the recorder 16. The recorder 16 stores the image file. The image data to be processed is created immediately after photographing, or retrieved from storage in the recorder 16. The digital filter is used to add visual effects to the image data, and includes, for example, a monochrome filter, a sepia filter, a color filter, or a fish-eye filter. The processing involving the digital filter is a visual effects process.

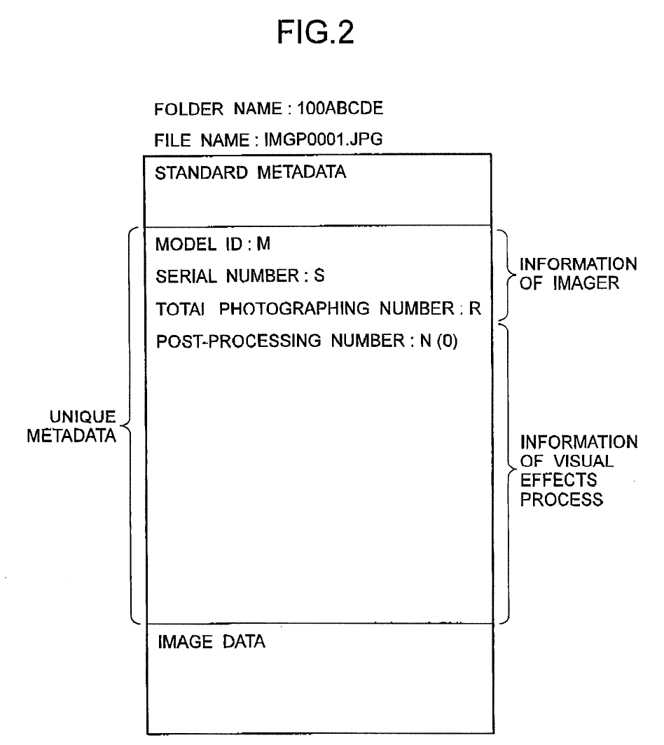

The file structure of the image file is described hereinafter. In the case that the visual effects process is not carried out, the image processor writes both standard metadata and unique metadata to the image file (FIG. 2). The standard metadata includes the photographing date, shutter speed, aperture value (F number), ISO value, etc., according to the exchangeable image file format (Exif). The unique metadata includes the model ID (M), serial number (S), total photographing number (R), and post-processing number (N). The model ID (M) consists of characters assigned for each different model. The serial number (S) is assigned for each manufactured device.

The total photographing number (R) reflects the cumulative quantity of photographing, and is integrated from the time of shipping.

The post process comprises a first process and a second process. In the first process, the image processor 13 carries out the visual effects process one or more times immediately after photographing, and then the recorder 16 stores the image file created according to the visual effects process. In the second process the image processor 13 retrieves the image file from the recorder 16, carries out the visual effects process one or more times, and then the recorder 16 stores the image file created according to the visual effects process.

The post-processing number (N) is the number of times the second process is conducted, and is integrated for each image file from the moment of creation. The initial value of the post-processing number (N) is zero. That is, the post-processing number of an image file created immediately after photographing is zero. The post-processing number (N) is increased incrementally by one every time the second process is carried out.

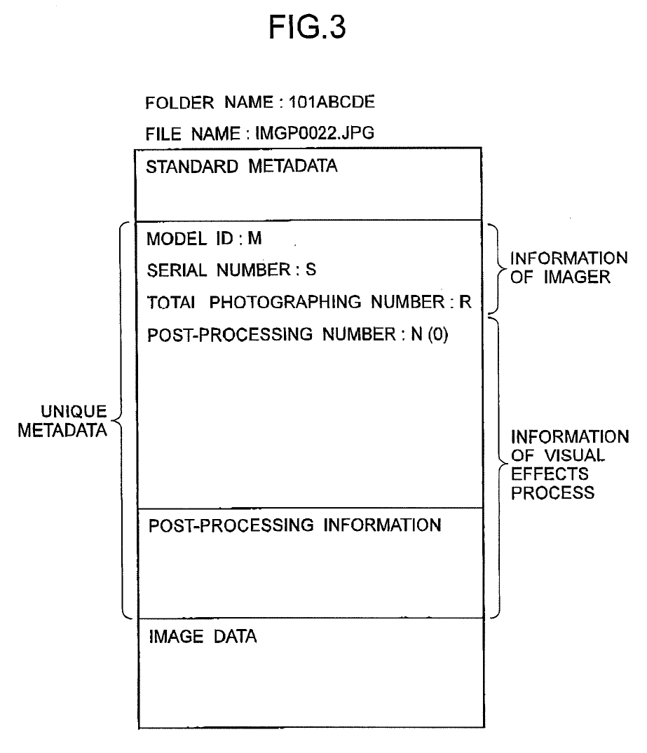

During the first process, the image processor 13 adds standard metadata, unique metadata, and post-processing information to the image file (FIG. 3). The recorder 15 then stores the processed image file. In the first process, the unique metadata includes the model ID (M), the serial number (S), the total photographing number (R), and the post-processing number (N).

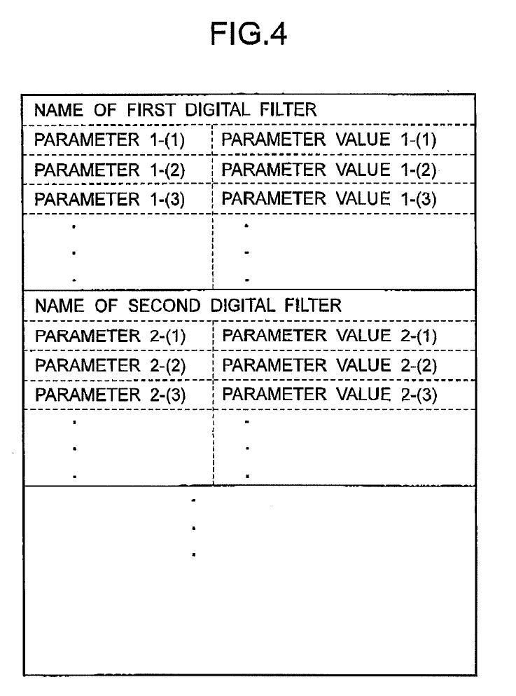

The post-processing information is based on the visual effects, and includes the name of the digital filter, parameters of the digital filter, and values of the parameters (FIG. 4). In the case that multiple digital filters are applied to the image data, the post-processing information is added to the image file in the same order that the digital filters were applied.

A soft filter is a particular digital filter that applies softening effects to an image. Post-processing information related to the soft filter is described hereinafter. The name of the digital filter is “soft”. The parameters of the digital filter are “level of soft focus” and “softness of shadow”. The values of the parameter corresponding to the level of soft focus are designated by numerals and indicate the degree of soft focus. The values of the parameter corresponding to the softness of shadow consist of either “1” or “0”, and indicate existence or nonexistence of soft focus.

A retro filter is another digital filter, which applies retro effects to an image to make it appear older than it actually is. The post-processing information of the retro filter is described hereinafter. The name of the digital filter is “retro”. The parameters of the digital filter are “color tone” and “edge of subjects”. The values of the parameter corresponding to the color tone are designated by numerals. The values of the parameter corresponding to the edge of subjects are also designated by numerals and indicate the level and or existence of enhancement of the edge of a subject.

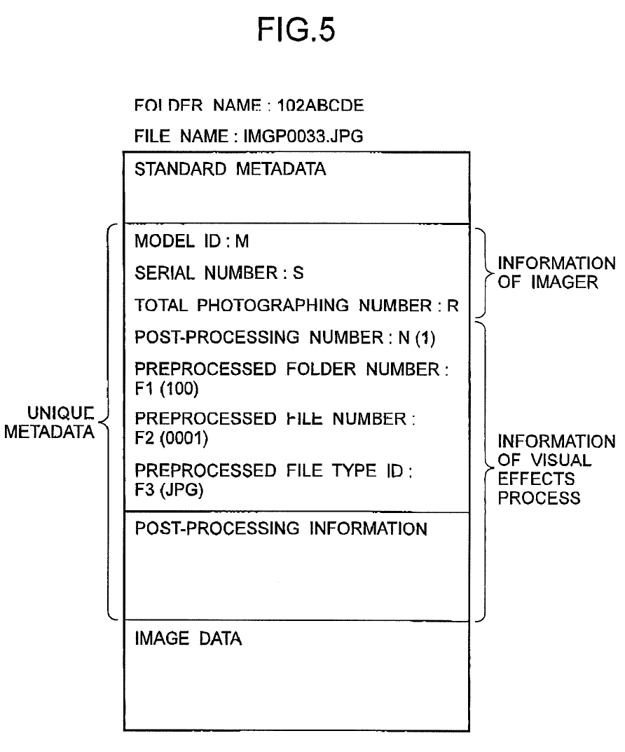

In the case that first the soft filter followed by the retro filter are applied to the image data, the first post-processing information includes the name of the first digital filter “soft”, the first parameter of the first digital filter “level of soft focus”, the second parameter of the first digital filter “softness of shadow”, the value of the first parameter corresponding to “level of soft focus”, and the value of the second parameter corresponding to “existence or nonexistence of soft focus”. The second post-processing information includes the name of the second digital filter “retro”, the first parameter of the second digital filter “color tone”, the second parameter of the second digital filter “edge of subjects”, the value of the first parameter corresponding to “color tone”, and the value of the second parameter corresponding to “edge of subjects”. During the second process, the image processor adds standard metadata, unique metadata, and post-processing information to the image file (FIG. 5). Then, the recorder 15 stores the enhanced image file. In the second process, the unique metadata includes the model ID (M), the serial number (S), the total photographing number (R), the post-processing number (N), image file information created prior to the second process, and the post-processing information. The image file prior to undergoing the second process is a preprocessed image file.

The preprocessed image file is retrieved from the recorder 16 for visual effects processing, and it includes image data prior to undergoing the latest second process. The preprocessed image file information includes its folder number (F1), file number (F2) and file type ID (F3). The construction of folders and files is based on the DCF (Design rule for Camera File system). Therefore, the names of folders and files are identified if the folder number (F1) or the file number (F2) includes at least part of the names of folders or files. The file type ID (F3) indicates the file format. For example, in the case that “JPG” is stored in the file type ID (F3), the file format is jpeg. In the case that the preprocessed image file has the file name “IMG0001.JPG” and is stored in the folder “100ABCDE” as illustrated in FIG. 2, it is processed one time under the second process and an image file is created (FIG. 5). In the image file illustrated in FIG. 5, the model ID (M), the serial number (S), and the total photographing number (12) do not change, i.e. these values are the same as they were in the preprocessed image file. Otherwise, the post-processing number (N) is set to one, the folder number (F1) is set to 100, the file number (F2) is set to “0001” and the file type (F3) is set to “JPG”. The image file illustrated in FIG. 5 has the standard metadata, the unique metadata and the image data. The unique metadata includes the model ID (M), the serial number (S), the total photographing number (R), the post-processing number (N), the folder number (F1), the file number (F2), the file type (F3) and the post-processing information.

The post-processing information is used in the display of the post process flow, and is used when other image data undergoes visual effects processing that is based on the post-processing information.

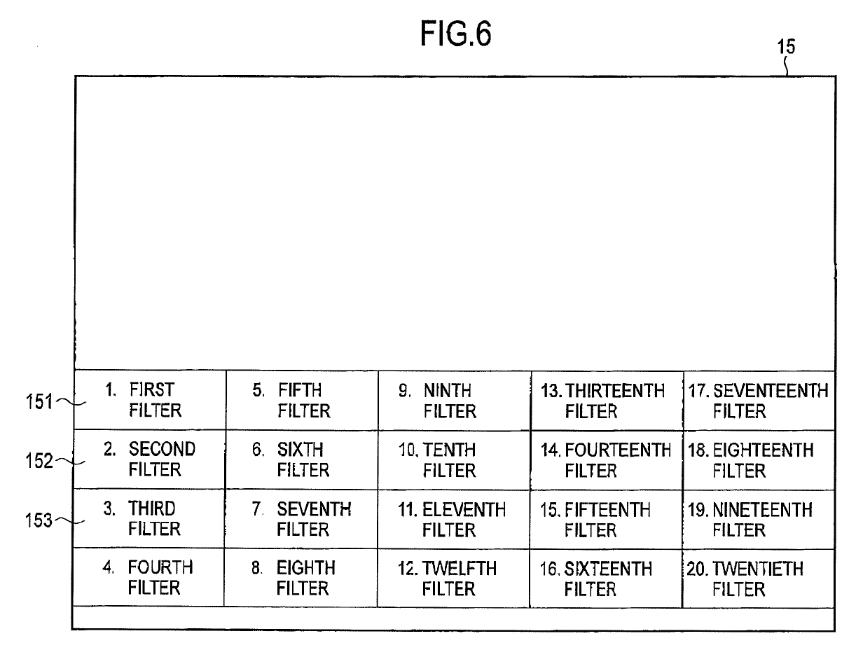

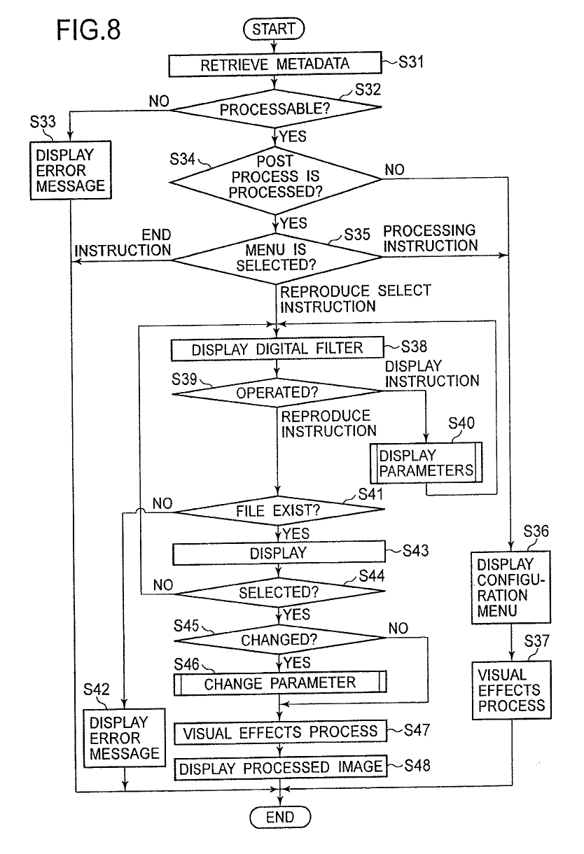

In the case that a user manipulates the operating device 14 for a certain method (the second operation) while an image that has already undergone a post-processing operation (the first and second processes) is represented on the display 15, the image processor 13 exhibits the post-processing information for the image shown on the display (FIG. 6, and Step S38 of FIG. 8). The names of the digital filters applied during post processing are arranged in the order of their selection by a user, and are represented on the display 15. In the case that the soft filter is first applied to the image data and then the retro filter is applied second, an icon corresponding to the soft filter is represented on a first field 151 in the display 15 and an icon corresponding to the retro filter is represented on a second field 152 in the display 15. The third field 153 and all following fields in the display 15 are blank.

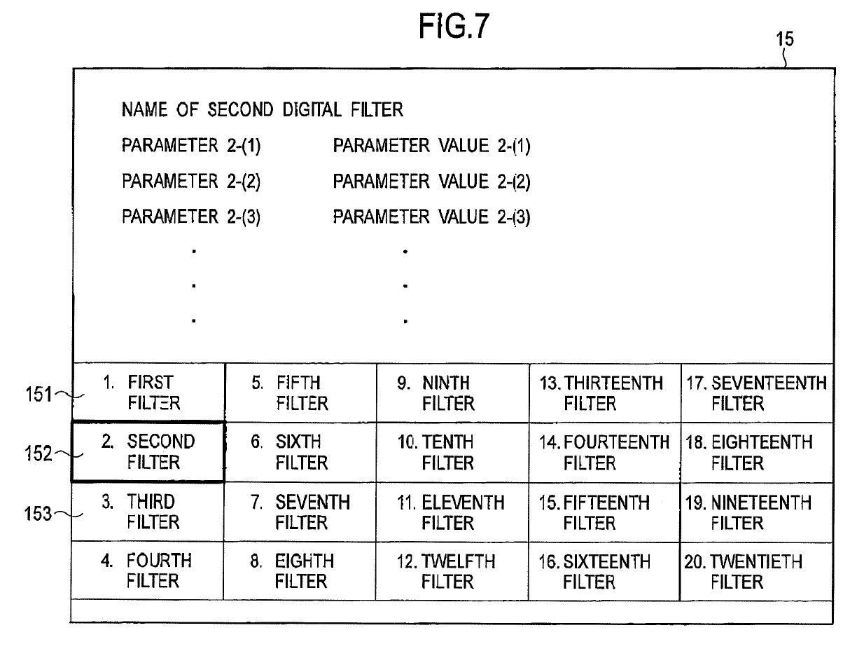

In the case that a user operates the operating device 14 for a certain method (the third operation) while the post-processing information is represented on the display 15 as illustrated in FIG. 6, the image processor 13 indicates the parameters of the digital filters and the values of those parameters along with the post-processing information of the represented image on the display (FIG. 7, and Step S40 of FIG. 8). For example, the third operation is an operation such that a user selects one of the icons corresponding to the name of the digital filter represented on the display 15. FIG. 7 illustrates the display 15 when a user selects the second field 152 in which the name of the second digital filter is represented.

In the case that a user operates the operating device 14 for a certain method (the fourth operation) while the post-processing information is represented on the display 15 as illustrated in FIG. 6 or 7, image data that has not been enhanced by the application of a digital filter is processed by the image processor 13 according to the represented post-processing information (Step S47 of FIG. 8). The process described in Step S47 of FIG. 8 is defined as a recurrence process.

Note that, in the fourth operation, a user can change the values of the parameters of the post-processing information, and the image processor may then undergo the recurrence process based on the modified parameters (Step S46 of FIG. 8).

The recurrence process is described with reference to FIG. 8. The recurrence process starts when a user operates the operating device 14 to indicate both an image file stored in the recorder 16 and a digital filter selection menu on the display 15. In Step S31, the image processor 13 retrieves the standard metadata and unique metadata recorded in the image file represented on the display 15.

In Step S32, the image processor 13 determines whether the image file of the represented image can be processed with the visual effects process based on the standard metadata and the unique metadata. Files that cannot to be processed with the visual effects process are not considered as targets of visual effect processing, for example image and movie files that are captured by another model In the case that an image file cannot undergo visual effects processing, the recurrence process continues to Step S33. Otherwise, the process proceeds to Step S34 when the image file can undergo visual effects processing.

In Step S33, the image processor 13 shows a message indicating that the image file for the image appearing on the display 15 cannot undergo visual effects processing. After that, the recurrence process ends.

In Step S34, the image processor 13 determines whether the image data of the represented image has undergone post processing. More precisely, the image processor 13 determines whether the unique metadata includes the post-processing information. In the case that the post-processing information is included, the image processor 13 determines that the image data has undergone post processing and the recurrence process continues to Step S35. In the case that the post-processing information is not included, the image processor 13 determines that the image data has not undergone post processing and the process proceeds to Step S36.

In Step S35, the image processor 13 presents a selection menu on the display 15.

The selection menu has first to third items. In the case a user selects the first item by manipulating the operating device 14, the image processor 13 ends the recurrence process. In the case a user selects the second item by using the operating device 14, the process continues to Step S36 and the visual effects process is repeated. In the case a user selects the third item, i.e. the second operation, by using the operating device 14 the process proceeds to Step S38 and the preprocessed image file is reproduced.

In Step S36, the image processor 13 presents a configuration menu on the display 15. A user configures the visual effects process by inputting the name of a digital filter, a parameter or the digital filter, and a value of the parameter into the configuration menu. This operation conducted by the user is the first operation.

In Step S37, the image processor 13 carries out the second process based on the configured visual effects process, and the processed image file is created. The processed image file, which is stored in the recorder 16, contains both the post-processing information and the image data processed during the second process. After that, the image based on the processed image file is represented on the display 15 and the recurrence process ends.

In Step S38, the name of the digital filter used in the post processing is displayed by the image processor 13 over the represented image (FIG. 6).

In Step S39, the image processor 13 determines whether a user manipulates the operating device 14 to carry out the third operation and/or proceeds with the fourth operation by executing the recurrence process. The third operation represents the parameters of the digital filter and the values of the parameters on the display 15 when a user selects an icon with the name of the digital filter on the display 15.

In the case that the third operation is carried out, the image processor 13 displays the name of the digital filter, the parameters of the digital filter, and the values of the parameters for the displayed image in Step S40 (FIG. 7). After that, the process returns to Step S39.

In the case that the fourth operation is carried out, the image processor 13 determines whether or not unprocessed image data is stored in the recorder 16 in Step S41. In the case that such image data is not stored, the image processor 13 indicates on the display 15 that the image file contains image data that can be processed in the recurrence process. After that, the recurrence process ends. In the case that such image data is stored, the process proceeds to Step S43.

In Step S43, the image processor 13 displays one of the image files that has not undergone post processing so that a user can select the represented image file. The displayed image file includes image data that can be processed in the recurrence process.

In Step S44, the image processor 13 determines whether a user selects the image file with the operating device 14. Note that, the camera controller 17 may determine whether a user selects the image file with the operating device 14 in Step S44. In the case that a user selects an image file, the process proceeds to Step S45. In the case that a user does not select an image file and instead uses the operating device 14 to return the display 15 the post-processing information, the process returns to Step S38.

In Step S45, the image processor 13 determines whether a use operates the operating device 14 so as to change the display 15 to a screen through which a user can select a different digital filter and change the value of a parameter. In the case that a user operates the operating device 14 so as to change the screen indicated on the display 15, the process continues to step S46, otherwise, the process proceeds to Step S47.

In Step S46, the image processor 13 presents a screen for changing the parameter values on the display 15 (FIG. 7). A user operates the operating device 14 so as to select the digital filter, its parameter, and the parameter's value.

In Step S47, the image processor 13 carries out the recurrence process with respect to the selected image file so that a processed image file is created. The processed image file contains both the post-processing information and the image data processed by the recurrence process, and is stored in the recorder 16. In the case that the value of the parameter is modified in Step S46, the recurrence process is applied to the selected image file based on the new value.

In Step S48, the display 15 represents the image based on the image file that has undergone the recurrence process, and then the recurrence process ends. It is difficult, in general, for a user to recognize how visual effects are applied and whether or not an image has undergone post processing when the user only views the represented image. Especially, in the case that multiple visual effects are applied to the image data, it is difficult for a user to recognize how visual effects are applied only by viewing a represented image.

According to the embodiment, the image file includes the post-processing information. Therefore, a user can recognize how visual effects are applied by referring to the post-processing information. The image processor 13 indicates the name of the digital filter based on the post-processing information of the image on the display 15 as a function of the second operation, so that a user can easily recognize the history of the post process. A user can identify the post-processing information by using a computer equipped with a software application for retrieving post-processing information from the image file. The image processor 13 indicates on the display 15 the name of the digital filter, its parameter and the parameter's value as a function of the third operation, so that a user can recognize the post-processing information.

Part of the post process may be applied to other image data by carrying out the recurrence process.

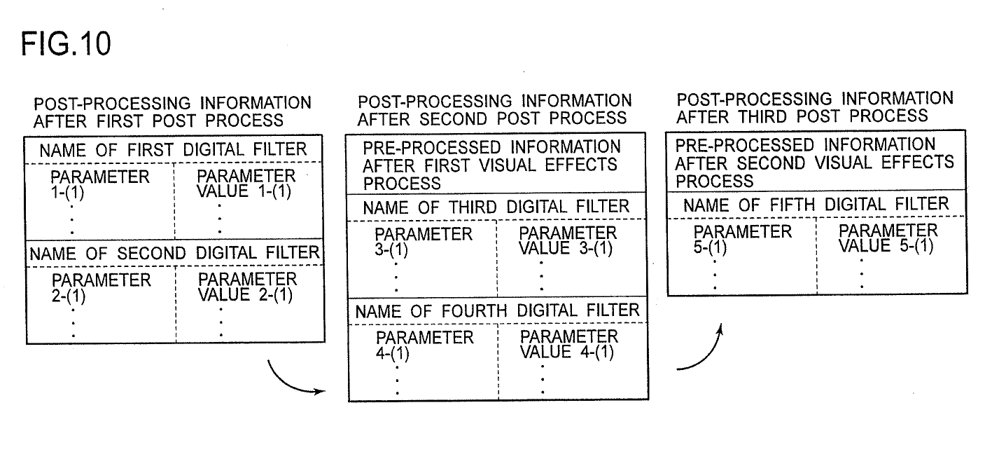

According to the embodiment, the post-processing information includes the name, parameter and parameter value of the digital filter, however, the information maintained in the image file prior to the second process and the post-processing information from the second process may also be included in the post-processing information (FIG. 10). The amount of data recorded in the metadata storage area may be reduced.

The construction illustrated in FIG. 10 is described hereinafter. In the case that two visual effects (first and second visual effects) are applied to the image data in the first post process, and then two visual effects (third and fourth visual effects) are applied to the image data in the second post process, the image file created after the second post process includes post-processing information that contains image file information recorded after the first post process and post-processing information related to the third and fourth visual effects. After that, a visual effects procedure (fifth visual effect) is carried out on the image data in the third post process, and the image file created after the third post process includes post-processing information that contains image file information recorded after the second post process and post-processing information related to the fifth visual effect.

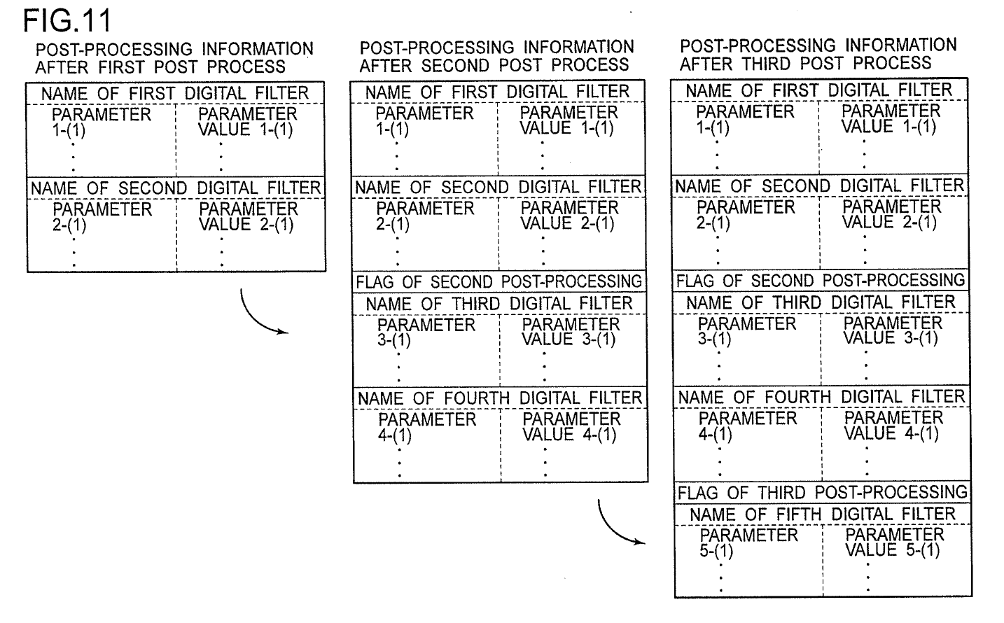

The post-processing information may have flags, which indicate that the image file has a history of visual effects in addition to the history recorded in the image file (FIG. 11).

In the case that two visual effects (first and second visual effects) are applied to the image data in the first post process, and then two visual effects (third and fourth visual effects) are applied to the image data in the second post process, the image file created after the second post process includes post-processing information with a second flag inserted after the post-processing information pertaining to the second visual effects. After that, a visual effect (fifth visual effect) is applied to the image data in the third post process, the image file created after the third post process includes a third flag inserted after the post-processing information of the fifth visual effect (FIG. 11).

Therefore, a user can apply each post process to the image data.

Note that the visual effect may be a resizing or trimming effect. The resizing effect changes the size of an image. The trimming effect clips the outer portion of the image.

Although the embodiment of the present invention has been described herein with references to the accompanying drawings, obviously many modifications and changes may be made by those skilled in the art without departing from the scope of the invention.

The present disclosure relates to subject matter contained in Japanese Patent Application No. 2009-117343 (filed on May 14, 2009), which is expressly incorporated herein, by reference, in its entirety.

1. An imager comprising:
an imaging sensor that creates an image signal by photographing a subject; and
an image processor that creates image data by processing the image signal, conducts a visual effects process, and stores post-processing information that includes information based on the visual effects process in the image data, so that an image file is created.

2. The imager according to claim 1 further comprising a display that displays the post-processing information stored in the image data.

3. The imager according to claim 1, wherein said image processor processes additional image data based on the post-processing information.

4. The imager according to claim 3, wherein said image processor conducts post processing in which more than one visual effects process is carried out, and the post-processing information includes information to distinguish between visual effects processes processed in two different post-processes.

5. The imager according to claim 3, wherein said image processor creates an image file that includes the post-processing information and additional image data that is processed based on the post-processing information.

6. The imager according to claim 3 further comprises an operating device that changes the configuration of the visual effects process, and wherein said image processor processes additional image data that is based on the modified configuration of the visual effects process.

7. The imager according to claim 1, wherein said image processor processes other image data that is not processed during post-processing, based on the post-processing information.

8. The imager according to claim 1 further comprising a recorder that stores the image file, and wherein the post-processing information contains information from the image file that is stored in said recorder before retrieval from said recorder for visual effects processing, the post-processing information is processed after retrieval of the image file.

9. The imager according to claim 1, wherein the visual effects process has at least one of either a digital, resizing or trimming effect.

10. An image producer comprising:
an image processor that creates image data, conducts a visual effects process, and stores post-processing information that includes information based on the visual effects process in the image data, so that an image file is created; and
a display that displays the post-processing information stored in the image data.
